(19) United States
(12) Patent Application Publication
(10) Pub. No.: US 2016/0145119 A1
(43) Pub. Date: May 26, 2016

(54) Water Purification Valve Core

(71) Applicant: Xiamen Runner Industrial Corporation, Xiamen (CN)

(72) Inventors: Jin-Fa Wang, Xiamen (CN); Xi-Min Chen, Xiamen (CN); Zhang-Sheng Li, Xiamen (CN)

(21) Appl. No.: 14/858,917

(22) Filed: Sep. 18, 2015

(30) Foreign Application Priority Data
Nov. 25, 2014 (CN) 201420714753.4

(51) Int. Cl. C02F 1/00; B01D 35/04

(52) U.S. Cl. CPC C02F 1/003; B01D 35/04

(57) ABSTRACT

A water purification core valve includes a shell having a top opening and a bottom opening. A cam bushing, a cam, a movable tile and a stationary tile are mounted inside the shell. A central portion of the cam is pivotally mounted to the cam bushing and a top portion protrudes beyond the top opening of the shell and is connected to a handle. The movable tile has a cam opening formed through the movable tile for the bottom portion of the cam to be inserted therein. Five water paths formed through the stationary tile and the movable tile and are respectively connected with three water inputs and two water outputs. The water purification core valve is operated by pivoting the handle to align the water paths to corresponding water supply, thereby fulfilling control over three ways of water input and two ways of water output.

### FIELD OF THE INVENTION

The present invention relates to a faucet valve core and, more particularly, to a water purification valve core.

### DESCRIPTION OF THE RELATED ART

Currently, because water quality is getting worse, people usually mount a water purifier to filter tap water for drinking purpose. Unfiltered tap water serves for cleaning purpose. To that end, two sets of control valves and waterways are required, thus causing inconvenient in operation and mounting.

### SUMMARY OF THE INVENTION

In view of the problems and drawbacks of the prior art, the objective of the present invention is to provides a water purification valve core capable of controlling water inputs and outputs of a water purification device and a mixed water supply device. To achieve the foregoing objective, the water purification valve core includes a shell, a cam bushing, a cam, a movable tile and a stationary tile.

The shell is cylindrical and has an top opening and a bottom opening.

The cam bushing is mounted inside the shell.

The cam has a top portion, a bottom portion and a central portion.

The top portion is mounted through the cam bushing and protrudes beyond the top opening of the shell.

The central portion is located between the top portion and the bottom portion and is pivotally mounted on an inner wall of the cam bushing.

The movable tile is mounted inside the shell and has an upper movable plate and a lower movable plate.

The upper movable plate has a cam opening formed through the upper movable plate for the bottom portion of the cam to be inserted into the cam opening of the upper movable plate.

The lower movable plate is detachably connected with the upper movable plate and has a first recess and a slot.

The first recess is centrally formed in a bottom surface of the lower movable plate and communicates with the cam opening of the upper movable plate.

The slot is arc-shaped, is formed in the bottom surface of the lower movable plate, and is located beside the first recess.

The stationary tile has a lower stationary plate and an upper stationary plate.

The lower stationary plate has five passageways formed in a bottom surface of the lower stationary plate.

The upper stationary plate is detachably connected with the upper stationary plate and has five second recesses and five guide holes.

The five second recesses are formed in a bottom surface of the upper stationary plate and respectively communicate with the five passageways of the lower stationary plate.

The five guide holes are formed in a top surface of the upper stationary plate and respectively communicate with the five second recesses.

Preferably, the five passageways of the lower stationary plate are respectively connected with an inlet pipe and an outlet pipe of a water purification device and a cold water inlet pipe, a hot water inlet pipe and an outlet pipe of a cold and hot water supply device.

Preferably, the five guide holes include a mixed outlet hole, a pair of mixed inlet holes and a pair of filtered holes.

Preferably, the mixed outlet hole communicates with the passageway of the lower stationary plate adapted to communicate with the outlet pipe of the cold and hot water supply device.

Preferably, the pair of mixed inlet holes communicates with the passageways of the lower stationary plate adapted to communicate with the cold water inlet pipe and the hot water inlet pipe of the cold and hot water supply device and the pair of filtered holes communicates with the passageways of the lower stationary plate adapted to communicate with the inlet pipe and the outlet pipe of the water purification device.

Preferably, the upper stationary plate further has five seal grooves, and each seal groove is formed in an inner wall of one of the passageways for a seal ring to be inserted into the seal groove.

Preferably, the upper movable plate has three bumps formed around a perimeter of the bottom surface of the upper movable plate and the lower movable plate has three notches formed around a perimeter of a top surface of the lower movable plate and engaging the respective bumps of the upper movable plate, and the lower stationary plate has four tongues formed on a perimeter of a top surface of the lower stationary plate and the upper stationary plate has four breaches formed in a peripheral edge of the upper stationary and engaging the respective tongues of the lower stationary plate.

According to the foregoing description, the water purification valve core can be operated as follows. After the external handle connected with the top portion of the cam is pivoted in a direction and the bottom portion of the cam drives the movable tile to move horizontally, the pair of filtered holes are aligned and communicate with the passageways of the lower stationary plate for filtered water supply from the inlet pipe and outlet pipe of the water purification device. After the handle is further pivoted in an opposite direction and the first recess of the lower movable plate, and the mixed outlet hole and the pair of mixed inlet holes of the upper stationary plate are aligned and communicate with the respective passageways of the lower stationary plate respectively connected with the outlet pipe of the cold and hot water supply device and a cold and hot inlet pipes of the cold and hot water supply device for mixed water supply from the cold and hot water supply device to fulfill control over three ways of water input and two ways of water output.

### BRIEF DESCRIPTION OF THE DRAWINGS

The detailed description of the drawings particularly refers to the accompanying figures in which:

FIG. 1 is an exploded perspective view of a water purification valve core in accordance with the present invention;

FIG. 2 is a perspective view of a lower movable plate of the water purification valve core in FIG. 1;

FIG. 3 is another perspective view of the lower movable plate in FIG. 2;

FIG. 4 is a perspective view of a lower stationary plate in FIG. 1;

FIG. 5 is another perspective view of the lower stationary plate in FIG. 4; and

FIG. 6 is another exploded perspective view of the water purification valve core in FIG. 1.

### DETAILED DESCRIPTION OF THE INVENTION

The purpose, construction, features, functions and advantages of the present invention can be appreciated and understood more thoroughly through the following detailed description with reference to the attached drawings.

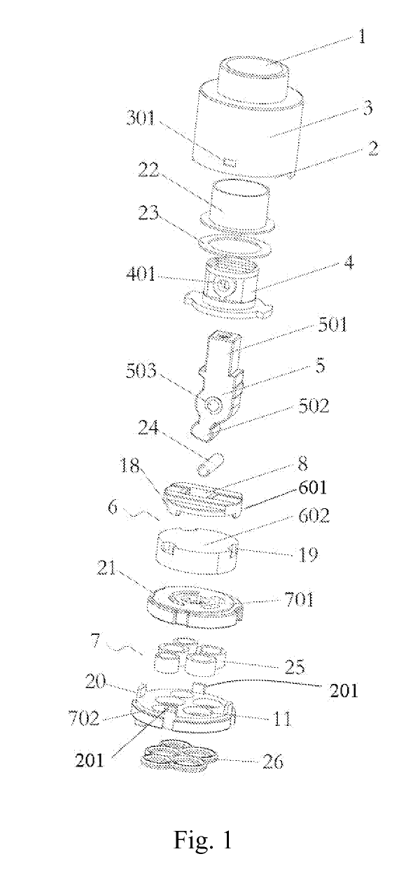

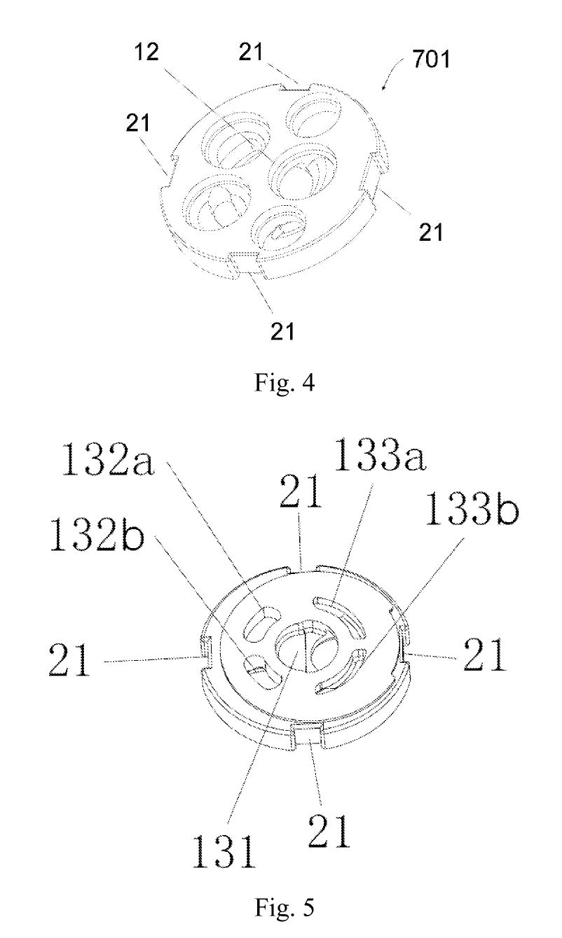

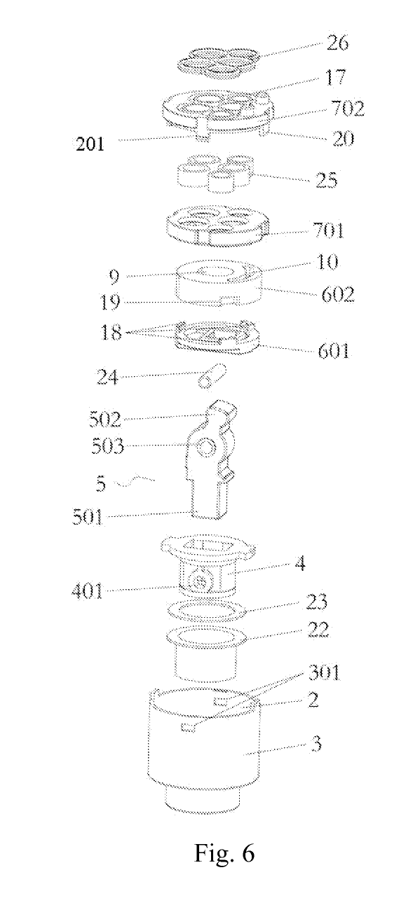

With reference to FIGS. 1-6, a water purification valve core in accordance with the present invention includes a shell 3, a cam bushing 4, a cam 5, a movable tile 6 and a stationary tile 7. The shell 3 is cylindrical and has a top opening 1 and a bottom opening 2. The cam bushing 4, the cam 5, the movable tile 6 and the stationary tile 7 are mounted inside the shell 3.

The cam bushing 4 has a pin hole 401 laterally formed through a peripheral wall of the cam bushing 4. The cam 5 has a top portion 501, a pivot hole 503 and a bottom portion 502. The top portion 501 is mounted through the cam bushing 4 and protrudes beyond the top opening 1 of the shell 3. The pivot hole 503 is formed through the cam 5 and is located between the top portion 501 and the bottom portion 502. The cam 5 is pivotally mounted on an inner wall of the cam bushing 4 with a pivot pin 24 mounted through the pin hole 401 of the cam bushing 4 and the pivot hole 503.

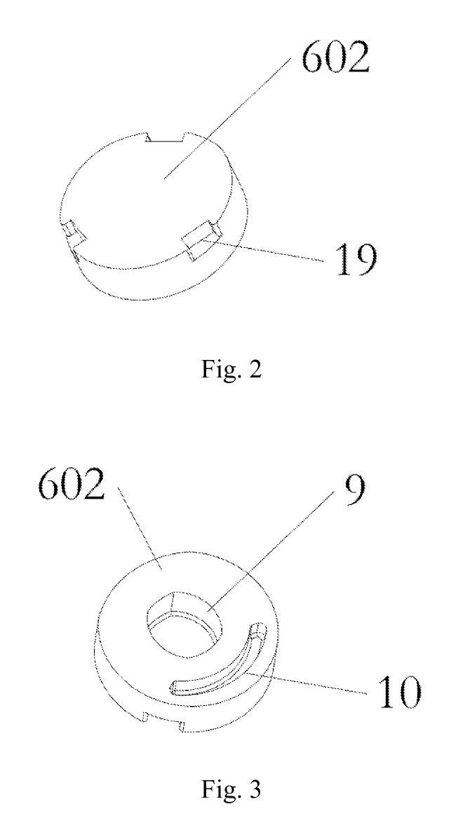

The movable tile 6 has an upper movable plate 601 and a lower movable plate 602 detachably connected with the upper movable plate 601. The upper movable plate 601 has a cam opening 8 and three bumps 18. The cam opening 8 is formed through the upper movable plate 601. The bottom portion 502 of the cam 5 is inserted into the cam opening 8 of the upper movable plate 601. The three bumps 18 are formed around a perimeter of a bottom surface of the upper movable plate 601 and spaced apart from each other by gaps. With reference to FIGS. 2 and 3, the lower movable plate 602 has a first recess 9 and a slot 10. The first recess 9 is centrally formed in a bottom surface of the lower movable plate 602 and communicates with the cam opening 8 of the upper movable plate 601. The slot 10 is arc-shaped, is formed in the bottom surface of the lower movable plate 602, and is located beside the first recess 9. The lower movable plate 602 further has three notches 19 formed around a perimeter of a top surface of the lower movable plate 602 and engaging the is respective bumps 18.

The stationary tile 7 includes an upper stationary plate 701 and a lower stationary plate 702. The lower stationary plate 702 is detachably connected with the upper stationary plate 701 and has five passageways 11 and four tongues 20. The five passageways 11 are formed in a bottom surface of the lower stationary plate 702 and are respectively connected with an inlet pipe and an outlet pipe of a water purification device and a cold water inlet pipe, a hot water inlet pipe and an outlet pipe of a cold and hot water supply device. The lower stationary plate 702 further has a seal groove 26. The seal groove 26 is formed in an inner wall of one of the passageways 11 for a seal ring to be inserted into the seal groove 26. The four tongues 20 are formed on a perimeter of a top surface of the lower stationary plate 702 and spaced apart from each other by gaps. The upper stationary plate 701 is detachably connected with the lower stationary plate 702 and has five second recesses 12 and five guide holes. The five second recesses 12 are formed in a bottom surface of the upper stationary plate 701 and respectively communicate with the passageways 11 of the lower stationary plate 701. The five guide holes are formed in a top surface of the upper stationary plate 701 and respectively communicate with the second recesses 12 of the lower stationary plate 702. The guide holes include a mixed outlet hole 131, a pair of mixed inlet holes 132a, 132b and a pair of filtered holes 133a, 133b. The mixed outlet hole 131 communicates with the passageway 11 of the lower stationary plate 701 that communicates with the outlet pipe of the cold and hot water supply device. The pair of mixed inlet holes 132a, 132b communicates with the passageways 11 of the lower stationary plate 701 that communicate with the cold water inlet pipe and the hot water inlet pipe of the cold and hot water supply device. The pair of filtered holes 133a, 133b communicates with the passageways 11 of the lower stationary plate 701 that communicate with the inlet pipe and the outlet pipe of the water purification device. The upper stationary plate 701 further has five seal grooves 25 and four breaches 21. Each seal groove 25 is formed in an inner wall of one of the passageways 11 for a seal ring to be inserted into the seal groove 25. The breaches 21 are formed in a peripheral edge of the upper stationary plate 701, are spaced apart from each other by gaps, and engage the respective tongues 20 of the lower stationary plate 702 to combine the upper stationary plate 701 and lower stationary plate 702 together.

The first recess 9 communicates with the mix outlet hole 131 of the upper stationary plate 701.

After the stationary tile 7, the movable tile 6, the cam 5 and the cam bushing 4 are combined, a protection cover 22 is mounted around a periphery of the cam bushing 4 with a gasket 23 mounted between the cam bushing 4 and the protection cover 22. The protection cover 22 and gasket 23 can reduce abrasion against the periphery of the cam bushing 4.

Furthermore, the foregoing combined elements are mounted into the shell 1 through the bottom opening 2 of the shell. Meanwhile, the top portion 501 of the cam 5 protrudes beyond the top opening 1 and is connected with an external handle (not shown).

The top end of each tongue 20 has a bulged portion 201 is inserted into one of multi fixing holes 301 formed in a periphery of the shell 1. The bulge portion 201 allows secure assembly of the water purification valve core. The operation of the water purification valve core is described as follows.

After the external handle connected with the top portion 501 of the cam 5 is pivoted in a direction and the bottom portion of the cam 5 drives the movable tile 6 to move horizontally here are four water flow out situation, first, the pair of mixed inlet holes 132a, 132b and mixed outlet hole 131 are aligned and communicate with the first recess 9 of the lower movable plate 602 for hot water and cold water flow into the mixed outlet hole 131, at same time, the pair of filtered holes 133a, 133b communicate with the slot 10 of the lower movable plate 602 for mixed water and filtered water supply from the inlet pipe and outlet pipe of the water purification device. Second, the mixed inlet holes 132a and mixed outlet hole 131 are aligned and communicate with the first recess 9 of the lower movable plate 602 for hot water flow into the mixed outlet hole 131, at same time, the pair of filtered holes 133a, 133b communicate with the slot 10 of the lower movable plate 602 for hot water and filtered water supply from the inlet pipe and outlet pipe of the water purification device. Third, the mixed inlet holes 132b and mixed outlet hole 131 are aligned and communicate with the first recess 9 of the lower movable plate 602 for cold water flow into the mixed outlet hole 131, at same time, the pair of filtered holes 133a, 133b communicate with the slot 10 of the lower movable plate 602 for cold water and filtered water supply from the inlet pipe and outlet pipe of the water purification device. Fourth, the first recess 9 of the lower movable plate 602 communicate with the mixed outlet hole 131, and the pair of mixed inlet holes 132a, 132b and the filtered holes 133a, 133b of the upper stationary plate 701 are press against with the lower movable plate 602, to form water can't flow out.

After the handle is further pivoted in an opposite direction and the first recess 9 of the lower movable plate 602, and the mixed outlet hole 131 and the pair of mixed inlet holes 132a, 132b of the upper stationary plate 701 are aligned and communicate with the respective passageways 11 of the lower stationary plate 702 respectively connected with the outlet pipe of the cold and hot water supply device and a cold and hot inlet pipes of the cold and hot water supply device for mixed water supply from the cold and hot water supply device to fulfill control over three ways of water input and two ways of water output.

What is claimed is:

1. A water purification valve core comprising:
a shell being cylindrical and having an top opening and a bottom opening;
a cam bushing mounted inside the shell;
a cam having:
a top portion mounted through the cam bushing and protruding beyond the top opening of the shell;
a bottom portion; and
a central portion located between the top portion and the bottom portion and pivotally mounted on an inner wall of the cam bushing; and
a movable tile mounted inside the shell and having:
an upper movable plate having a cam opening formed through the upper movable plate for the bottom portion of the cam to be inserted into the cam opening of the upper movable plate; and
a lower movable plate detachably connected with the upper movable plate, and having:
a first recess centrally formed in a bottom surface of the lower movable plate and communicating with the cam opening of the upper movable plate; and
a slot being arc-shaped, formed in the bottom surface of the lower movable plate, located beside the first recess; and
a stationary tile having:
a lower stationary plate having five passageways formed in a bottom surface of the lower stationary plate; and
an upper stationary plate detachably connected with the upper stationary plate and having:
five second recesses formed in a bottom surface of the upper stationary plate and respectively communicating with the five passageways of the lower stationary plate; and
five guide holes formed in a top surface of the upper stationary plate and respectively communicating with the five second recesses.

2. The water purification valve core as claimed in claim 1, wherein the five guide holes include:
a mixed outlet hole communicating with the passageway of the lower stationary plate adapted to communicate with an outlet pipe of a cold and hot water supply device;
a pair of mixed inlet holes communicating with the passageways of the lower stationary plate adapted to communicate with a cold water inlet pipe and a hot water inlet pipe of the cold and hot water supply device; and
a pair of filtered holes communicating with the passageways of the lower stationary plate adapted to communicate with an inlet pipe and an outlet pipe of a water purification device.

3. The water purification valve core as claimed in claim 1, wherein the upper stationary plate further has five seal grooves, and each seal groove is formed in an inner wall of one of the passageways for a seal ring to be inserted into the seal groove.

4. The water purification valve core as claimed in claim 1, wherein the upper movable plate has three bumps formed around a perimeter of the bottom surface of the upper movable plate and the lower movable plate has three notches formed around a perimeter of a top surface of the lower movable plate and engaging the respective bumps of the upper movable plate; and
the lower stationary plate has four tongues formed on a perimeter of a top surface of the lower stationary plate and the upper stationary plate has four breaches formed in a peripheral edge of the upper stationary and engaging the respective tongues of the lower stationary plate.
